(19) United States
(12) Patent Application Publication
(10) Pub. No.: US 2019/0306785 A1
(43) Pub. Date: Oct. 3, 2019

(54) METHOD FOR PERFORMING ACCESS PROCEDURE WITH MOVING CELL IN WIRELESS COMMUNICATION SYSTEM, AND APPARATUS SUPPORTING SAME

(71) Applicant: LG ELECTRONICS INC., Seoul (KR)

(72) Inventors: Genebeck HAHN, Seoul (KR); Ilmu BYUN, Seoul (KR); Heejeong CHO, Seoul (KR); Eunjong LEE, Seoul (KR)

(73) Assignee: LG ELECTRONICS INC., Seoul (KR)

(21) Appl. No.: 15/762,973

(22) PCT Filed: Sep. 24, 2015
(86) PCT No.: PCT/KR2015/010072

§ 371 Date: Mar. 23, 2018

(51) Int. Cl. H04W 48/16; H04W 48/08

(52) U.S. Cl. CPC H04W 48/16; H04W 48/08

(57) ABSTRACT

The present specification provides a method for performing an access procedure with a moving cell by a terminal in a wireless communication system, the method comprising the steps of: receiving, from a base station, first system information (SI) including information associated with a moving cell access; and determining whether to access a moving cell on the basis of the information associated with the moving cell access.

### TECHNICAL FIELD

The present invention relates to a wireless communication system, and more particularly, to a method for performing an access procedure between a mobile station and a moving cell, and an apparatus supporting the same.

### BACKGROUND ART

A mobile communication system has been developed to provide a voice service, while guaranteeing activity of users. However, coverage of a mobile communication system has extended up to a data service, as well as the voice service, and currently, an explosive increase in traffic has caused shortage of resources, and since users expect relatively high speed services, an advanced mobile communication system is required.

Requirements of a next-generation mobile communication system include accommodation of explosive data traffic, a remarkable increase in a transfer rate per use, accommodation of considerably increased number of connection devices, very low end-to-end latency, and high energy efficiency. To this end, various technologies such as dual connectivity, massive multiple input multiple output (MIMO), in-band full duplex, non-orthogonal multiple access (NOMA), super wideband, and device networking have been researched.

### DISCLOSURE

### Technical Problem

An embodiment of the present invention provides a method for solving the problem that a legacy UE cannot distinguish between moving cells when different moving cells are adjacent to each other or when a moving cell approaches another moving cell.

That is, an embodiment of the present invention provides a method for preventing a legacy UE from accessing a moving cell using system information including information related to a moving cell access.

Furthermore, an embodiment of the present invention provides a method for newly defining a PCID used for identifying a moving cell.

Furthermore, an embodiment of the present invention provides a method of scrambling a PBCH and a PCFICH using a newly defined PCID.

### Technical Solution

In this disclosure, a method for performing an access procedure with a moving cell, by a user equipment (UE), in a wireless communication, includes: receiving, from a base station (BS), first system information (SI) including information related to a moving cell access; and determining whether to access the moving cell on the basis of the information related to the moving cell access, wherein the information related to the moving cell access includes at least one of closed subscriber group (CSG) indication information indicating whether a cell is a CSG cell or a normal cell, a CSG identity for identifying a CSG cell, a moving cell ID (MCID) for identifying a moving cell, and moving cell indication information indicating accessibility to a moving cell.

Also, in this disclosure, the method may further include: receiving second SI including information on mapping between the CSG ID and the MCID.

Also, in this disclosure, the mapping information between the CSG ID and the MCID may be information on a relationship in which one MCID group including the whole MCIDs is mapped to one CSG ID or a relationship in which N number of MCID groups are mapped to N number of CSG IDs in a one-to-one manner.

Also, in this disclosure, the determining of accessibility to the moving cell may include: determining whether the CSG ID included in the first SI is present in a CSG whitelist retained by the UE.

Also, in the method proposed in this disclosure, when the CSG ID included in the first SI is not present in the CSG whitelist, the UE may not access the moving cell.

Also, in this disclosure, the method may further include: when the CSG ID included in the first SI is present in the CSG whitelist, determining whether there is a mapping relationship between the CSG ID and the MCID through information on mapping between the CSG ID and the MCID.

Also, in the method proposed in this disclosure, when the mapping relationship between the CSG ID and the MCID is set through the information on mapping between the CSG ID and the MCID, the UE may not access the moving cell.

Also, in this disclosure, the method may further include: when the mapping relationship between the CSG ID and the MCID is set through the information on mapping between the CSG ID and the MCID, checking moving cell indication information corresponding to the MCID; and determining whether to access the moving cell on the basis of a result of checking the moving cell indication information.

Also, in this disclosure, the method may further include: when the moving cell indication information indicates permission for accessing the moving cell, performing an access procedure with the moving cell through detection of the MCID.

Also, in this disclosure, a method for performing an access procedure with a moving cell, by a user equipment (UE), in a wireless communication system, includes: receiving, from a base station (BS), a master information block (MIB) through a physical broadcast channel (PBCH); and receiving a control format indicator (CFI) through a physical control format indicator channel (PCFICH) from the BS, wherein the MIB and the CIF include information related to a moving cell access and the PBCH and the PCFICH are scrambled to a physical cell identity (PCID) of the moving cell.

Also, in this disclosure, the method may further include: performing an access procedure with the moving cell on the basis of the received MIB and CFI.

Also, in this disclosure, the PCID of the moving cell may be determined using at least one of an ID of a primary synchronization signal (PSS), an ID of a secondary synchronization signal (SSS), and an ID of a new synchronization signal (NSS).

Also, in this disclosure, a user equipment (UE) for performing an access procedure with a moving cell in a wireless communication system includes: a communication unit transmitting and receiving a radio signal to and from an external source; and a processor functionally coupled to the communication unit, wherein the processor performs control to receive first system information (SI) including information related to a moving cell access from a base station (BS) and determine whether to access the moving cell on the basis of the information related to the moving cell access, wherein the information related to the moving cell access includes at least one of closed subscriber group (CSG) indication information indicating whether a cell is a CSG cell or a normal cell, a CSG identity for identifying a CSG cell, a moving cell ID (MCID) for identifying a moving cell, and moving cell indication information indicating accessibility to a moving cell.

Also, in this disclosure, a user equipment (UE) for performing an access procedure with a moving cell in a wireless communication system includes: a communication unit transmitting and receiving a radio signal to and from an external source; and a processor functionally coupled to the communication unit, wherein the processor performs control to receive a master information block (MIB) through a physical broadcast channel (PBCH) from a base station (BS) and receive a control format indicator (CFI) through a physical control format indicator channel (PCFICH) from the BS, wherein the MIB and the CIF include information related to a moving cell access and the PBCH and the PCFICH are scrambled to a physical cell identity (PCID) of the moving cell.

### Advantageous Effects

In this disclosure, a legacy UE is not allowed to access a moving cell using system information including information related to a moving cell access and a PCID for a moving cell, thus solving a problem that the legacy UE performs an access procedure with respect to a wrong moving cell.

### DESCRIPTION OF DRAWINGS

FIG. 1 is a view schematically illustrating an E-UMTS network architecture of an LTE system as an example of a wireless communication system.

FIG. 2 is a view illustrating an example of a 5G mobile communication system to which the present invention may be applied.

FIG. 3 is a view illustrating physical channels used in a 3GPP LTE/LTE-A system and a general signal transmission method using the same, to which the present invention may be applied

FIG. 4 is a view illustrating an example of a radio frame transmitting a synchronization signal.

FIG. 5 is a view illustrating an example of a configuration of an SSS.

FIG. 6 is a view illustrating that a synchronization signal for a moving cell is transmitted in a frequency domain different from that of a legacy synchronization signal.

FIG. 7 is a view illustrating that a synchronization signal for a moving cell is transmitted in a frequency domain different from that of a legacy synchronization signal.

FIG. 8 is a flowchart illustrating an example of a method of performing an access procedure with a moving cell proposed in the present disclosure.

FIG. 9 is a flowchart showing another example of a method of performing a connection procedure with a moving cell proposed in this disclosure.

FIG. 10 is a block diagram illustrating a wireless device in which the methods proposed herein may be implemented.

### MODE FOR INVENTION

Reference will now be made in detail to the preferred embodiments of the present invention, examples of which are illustrated in the accompanying drawings. The detailed description set forth below in connection with the appended drawings is a description of exemplary embodiments and is not intended to represent the only embodiments through which the concepts explained in these embodiments can be practiced. The detailed description includes details for the purpose of providing an understanding of the present invention. However, it will be apparent to those skilled in the art that these teachings may be implemented and practiced without these specific details.

In some instances, known structures and devices are omitted, or are shown in block diagram form focusing on important features of the structures and devices, so as not to obscure the concept of the present invention.

In the embodiments of the present invention, the enhanced Node B (eNode B or eNB) may be a terminal node of a network, which directly communicates with the terminal. In some cases, a specific operation described as performed by the eNB may be performed by an upper node of the eNB. Namely, it is apparent that, in a network comprised of a plurality of network nodes including an eNB, various operations performed for communication with a terminal may be performed by the eNB, or network nodes other than the eNB. The term ‘eNB’ may be replaced with the term ‘fixed station’, ‘base station (BS)’, ‘Node B’, ‘base transceiver system (BTS),’, ‘access point (AP)’, etc. The term ‘user equipment (UE)’ may be replaced with the term ‘terminal’, ‘mobile station (MS)’, ‘user terminal (UT)’, ‘mobile subscriber station (MSS)’, ‘subscriber station (SS)’, ‘Advanced Mobile Station (AMS)’, ‘Wireless terminal (WT)’, ‘Machine-Type Communication (MTC) device’, ‘Machine-to-Machine (M2M) device’, ‘Device-to-Device (D2D) device’, wireless device, etc.

In the embodiments of the present invention, “downlink (DL)” refers to communication from the eNB to the UE, and “uplink (UL)” refers to communication from the UE to the eNB. In the downlink, transmitter may be a part of eNB, and receiver may be part of UE. In the uplink, transmitter may be a part of UE, and receiver may be part of eNB.

Specific terms used for the embodiments of the present invention are provided to aid in understanding of the present invention. These specific terms may be replaced with other terms within the scope and spirit of the present invention.

The following technology may be used in various wireless access systems, such as code division multiple access (CDMA), frequency division multiple access (FDMA), time division multiple access (TDMA), orthogonal frequency division multiple access (OFDMA), single carrier-FDMA (SC-FDMA), non-orthogonal multiple access (NOMA), and the like. The CDMA may be implemented by radio technology universal terrestrial radio access (UTRA) or CDMA2000. The TDMA may be implemented by radio technology such as Global System for Mobile communications (GSM)/General Packet Radio Service (GPRS)/Enhanced Data Rates for GSM Evolution (EDGE). The OFDMA may be implemented as radio technology such as IEEE 802.11 (Wi-Fi), IEEE 802.16 (WiMAX), IEEE 802-20, E-UTRA (Evolved UTRA), and the like. The UTRA is a part of a universal mobile telecommunication system (UMTS). 3rd generation partnership project (3GPP) long term evolution (LTE) as a part of an evolved UMTS (E-UMTS) using evolved-UMTS terrestrial radio access (E-UTRA) adopts the OFDMA in a downlink and the SC-FDMA in an uplink. LTE-advanced (A) is an evolution of the 3GPP LTE.

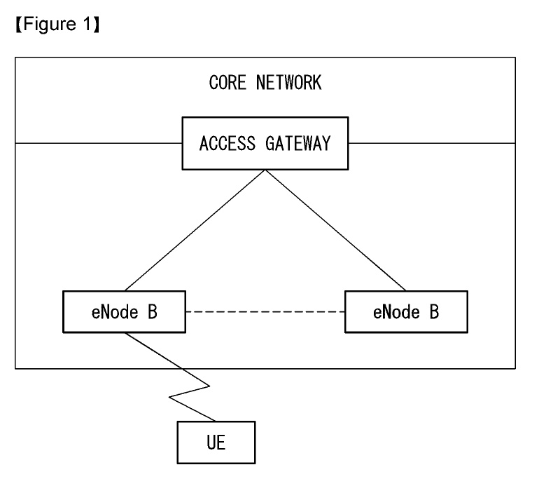

FIG. 1 is a view schematically illustrating an E-UMTS network architecture as an example of a wireless communication system.

The Evolved Universal Mobile Telecommunications System (E-UMTS) system is a system evolved from the existing Universal Mobile Telecommunications System (UMTS) and is currently undergoing basic standardization work in 3GPP. In general, the E-UMTS may be referred to as an LTE (Long Term Evolution) system. For details of the technical specifications of UMTS and E-UMTS, Release 7 and Release 8 of “3rd Generation Partnership Project (Technical Specification Group Radio Access Network)” may be referred to, respectively.

Referring to FIG. 1, the E-UMTS includes a user equipment (UE) and an access gateway (AG) located at an end of a BS (BS) (i.e., eNodeB) and connected to an external network. The BS may simultaneously transmit multiple data streams for a broadcast service, a multicast service, and/or a unicast service.

One or more cells exist in one BS. The cell is set to one of the bandwidths of 1.4, 2.5, 5, 10, 15, 20 Mhz, and the like to provide a downlink or uplink transmission service to a plurality of UEs. Different cells may be set up to provide different bandwidths.

The BS controls data transmission and reception for a plurality of terminals. Regarding downlink (DL) data, the BS transmits downlink scheduling information to provide, to a corresponding UE, information on a time/frequency domain in which data is to be transmitted, encoding, a data size, and HARQ (Hybrid Automatic Repeat and reQuest) related information, and the like. In addition, regarding uplink (UL) data, the BS transmits uplink scheduling information to provide, to the corresponding UE, information on a time/frequency domain, coding, a data size, and HARQ related information which may be used by the UE. An interface for transmitting user traffic or control traffic may be used between the BSs. A core network (CN) may include an AG and a network node for user registration of the UE. The AG and a network node for user registration of the UE. The AG manages mobility of the UE in units of TA (Tracking Area) including a plurality of cells.

In order to improve performance of the conventional LTE communication system as described above, 5G communication technology has been discussed, and the 5G communication scheme will support various types of cells as well as the conventional fixed type BS (eNode B).

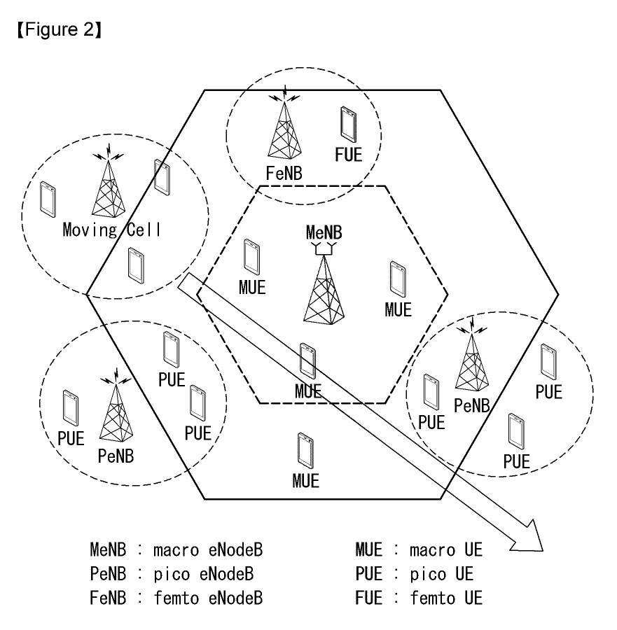

FIG. 2 is a view illustrating an example of a 5G mobile communication system to which the present invention may be applied.

As illustrated in FIG. 2, one macro cell may include macro UEs (MUEs) which are served by a macro BS (MeNB). In addition, FIG. 2 illustrates that pico cells are formed as microcells in a boundary region of macrocells and are served by pico BSs (pico eNBs: PeNBs) and femto BSs (femto eNBs: FeNBs) forming femto cells. A UE served by pico BSs may be represented as a pico UE (PUE) to be distinguished from the MUE.

In addition, a UE served by a femto BS may be represented as an FUE, distinguished from a MUE and a PUE.

The PeNB/FeNB is an example of a BS that provides services to a micro cell or a small cell, and various types of small BSs may correspond to PeNB/FeNB.

Since additional installation of the macro eNB is inefficient in terms of cost and complexity compared to improvement of system performance, it is expected that utilization of the heterogeneous networks based on installation of the micro eNB (or the small cell) as described above will be increased.

According to an architecture of a heterogeneous network currently considered in a communication network, a plurality of micro cells coexist in one micro cell and resources are allocated according to a cell coordination scheme to serve corresponding UEs.

In the “Small Cell Enhancements for EUTRA and E-UTRAN SI”, one of the standardization categories of 3GPP, it is discussed to enhance indoor/outdoor scenarios using low power nodes. Here, the benefits of the concept of dual connectivity with simultaneous connectivity to a macro cell layer and a small cell layer using the same or different carriers are discussed are under discussion.

Considering these trends, in the 5G wireless communication environment, more small cells are disposed to be more complicated than FIG. 2, and thus, end users are to be located more physically closer to a network.

In addition, the present invention assumes a radio environment in which a moving cell exists as another type of cell. Unlike a fixed type small cell which has been considered in 3GPP to date, a moving cell concept may be considered as an example of a small cell operating method that may be considered in a 5G wireless communication environment. The moving cell described hereinafter may be illustrated as a cell that provides more capacity to end users, while on the move, via a small BS installed in a bus, train or smart vehicle. That is, the moving cell may be defined as a mobile wireless node in a network forming a physical cell.

Using such a moving cell, group mobility may be provided to end users, and a large amount of concentrated traffic may be provided through a backhaul link. To this end, a backhaul from fixed infrastructures to buses, trains, and smart cars assumes wireless, and in-band communication inside buses, trains, and smart cars assumes full duplex.

Basic characteristics of potential application scenarios of the 5G moving cell to be handled in the present invention may be summarized as shown in Table 1 below.

TABLE 1

| | Backhaul | | Moving | Access link user |
|---|---|---|---|---|
| Category | distance | Mobility | pattern | load |
| Public | Long | Wide speed | Fixed | Medium/High |
| transportation | | range | | |
| Smart car | Medium/ | Wide speed | Arbitrary | Low/Medium |
| | Short | range | | |
| Personal cell | Various | Low speed | Arbitrary | Low/Medium |
| | | range | | |

As described above, in the 5G wireless communication environment, it is expected that moving cell-based communication, as well as conventional fixed small cell-based communication, is expected to be performed, and in order to enable moving cell-based communication, moving cell-specific technical problems or issues that differ from those of fixed small cell-based technical problems or issues need to be derived and addressed, which may have a major impact on current RANs.

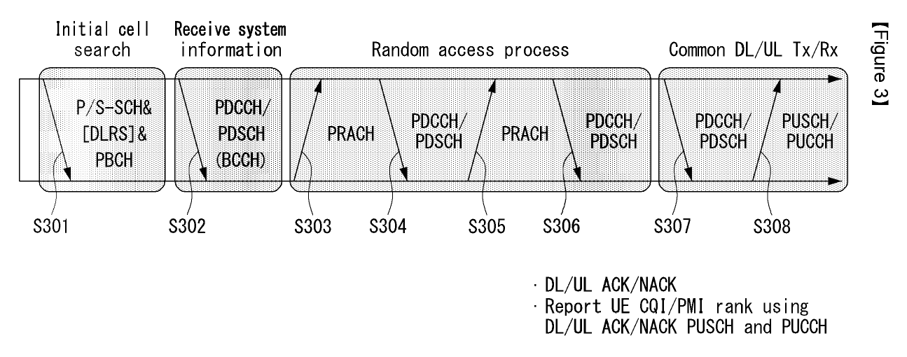

FIG. 3 illustrates physical channels and a view showing physical channels used for in the 3GPP LTE/LTE-A system to which the present invention can be applied.

When a UE is powered on or when the UE newly enters a cell, the UE performs an initial cell search operation such as synchronization with a BS in step S301. For the initial cell search operation, the UE may receive a Primary Synchronization Channel (P-SCH) and a Secondary Synchronization Channel (S-SCH) from the BS so as to perform synchronization with the BS, and acquire information such as a cell ID.

Thereafter, the UE may receive a physical broadcast channel (PBCH) from the BS and acquire broadcast information in the cell. Meanwhile, the UE may receive a Downlink Reference signal (DL RS) in the initial cell search step and confirm a downlink channel state.

The UE which completes the initial cell search may receive a Physical Downlink Control Channel (PDCCH) and a Physical Downlink Shared Channel (PDSCH) corresponding to the PDCCH, and acquire more detailed system information in step S302.

Thereafter, the UE may perform a random access procedure in steps S303 to S306, in order to complete the access to the BS. For the random access procedure, the UE may transmit a preamble via a Physical Random Access Channel (PRACH) (S303), and may receive a message in response to the preamble via the PDCCH and the PDSCH corresponding thereto (S304). In contention-based random access, a contention resolution procedure including the transmission of an additional PRACH (S305) and the reception of the PDCCH and the PDSCH corresponding thereto (S306) may be performed.

The UE which performs the above-described procedure may then receive the PDCCH/PDSCH (S307) and transmit a Physical Uplink Shared Channel (PUSCH)/Physical Uplink Control Channel (PUCCH) (S308), as a general uplink/downlink signal transmission procedure.

Control information transmitted from the UE to the BS is collectively referred to as uplink control information (UCI). The UCI includes hybrid automatic repeat and request acknowledgement/negative-acknowledgement (HARQ ACK/NACK), scheduling request (SR), channel quality information (CQI), precoding matrix indicator (PMI), rank indication (RI), etc. In the embodiments of the present invention, CQI and/or PMI are also referred to as channel quality control information.

In general, although a UCI is periodically transmitted via a PUCCH in the LTE system, this may be transmitted through a PUSCH if control information and traffic data are simultaneously transmitted. In addition, a UCI may be aperiodically transmitted via a PUSCH according to a network request/instruction.

Synchronization Signal (SS)

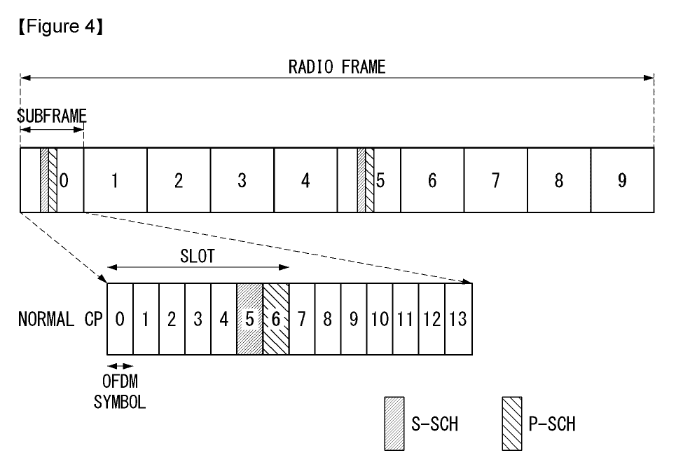

FIG. 4 illustrates an example of a radio frame transmitting a synchronization signal.

FIG. 4 illustrates a case where a synchronization signal is transmitted in an FDD radio frame.

Referring to FIG. 4, a PSS is mapped to the last OFDM symbols of the first slot (slot 0) and the eleventh slot (slot 10) in the radio frame.

An SSS is mapped to the second OFDM symbols at the end of the first slot and the eleventh slot in the radio frame.

The PSS is used to obtain OFDM symbol synchronization or slot synchronization and is associated with a physical layer cell identity (PCI). A sequence used for the PSS may be generated from a frequency domain Zadoff-Chu (ZC) sequence. A UE assumes that the PSS is not transmitted on an antenna port through which a downlink reference signal (RS) is transmitted.

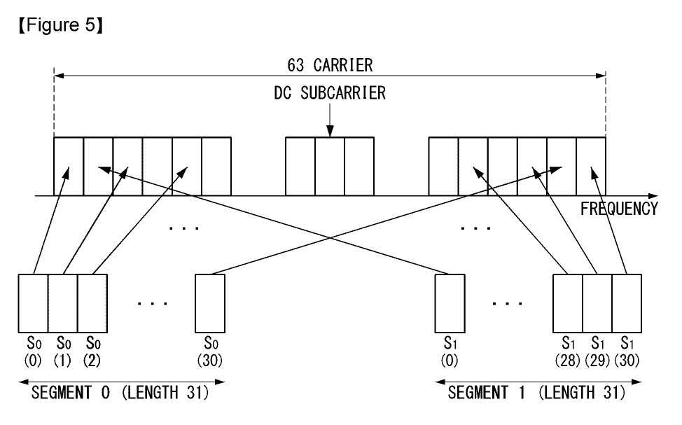

FIG. 5 illustrates an example of a configuration of the SSS.

The SSS is used to obtain frame synchronization. A sequence used for the SSS is an interleaved concatenation of two binary sequences having a length 31. Referring to FIG. 5, a segment 0 having a length of 31 may be represented by s0(0), . . . , s0(30), a segment 1 having a length of 31 may be represented by s1(0), . . . , s1(30).

Segment 0 and segment 1 are mapped to 62 subcarriers excluding a DC (direct current) subcarrier, among 63 subcarriers. Segment 0 and segment 1 are alternately mapped to 62 subcarriers. That is, the segment 0 and the segment 1 are mapped to a frequency domain in order of s0(0), s1(0), s0(1), s1(1), . . . , s0(30), s1(30). The linked sequence may be scrambled to a scrambling sequence given by the PSS. The two sequences defining the SSS are different in a first subframe (subframe 0) and a sixth subframe (subframe 5).

Hereinafter, a method of allocating a synchronization signal or a PCID defined in the LTE/LTE-A system will be described in detail.

In LTE/LTE-A, 504 unique physical layer cell IDs (PCID) are defined.

The PCIDs are grouped into 168 unique PCID groups, and each PCID group has three unique IDs.

Thus, one PCID is uniquely defined by a number (N_{ID}⁽¹⁾), which means a PCID group) present in the range of 0 to 167 and a number (N_{ID}⁽²⁾), which means a PCID of a PCID group) in the range of 0 to 2.

N_{ID}^{Cell}=3N_{ID}⁽¹⁾+N_{ID}⁽²⁾ [Equation 1]

N_{ID}⁽¹⁾ [symbol] corresponds to an SSS (Secondary Synchronization Signal) and N_{ID}⁽²⁾ corresponds to a PSS (Primary Synchronization Signal). A sequence d(n) used for the PSS is generated from a frequency domain Zadoff-Chu sequence, and a Zadoff-Chu root sequence index u is as shown in Table 2 below.

TABLE

| N_{ID}⁽²⁾ | Root index u |
|---|---|
| 0 | 25 |
| 1 | 29 |
| 2 | 34 |

Meanwhile, a sequence d(0), . . . , d(61) used for the secondary synchronization signal is defined as an interleaved concatenation of a 2 length-31 binary sequences.

The concatenated sequence is scrambled with a scrambling sequence given by the primary synchronization signal.

The combination of 2 length-31 sequences defining the secondary synchronization signal is different between subframe 0 and subframe 5, and 0≤n≤30.

$$d ( 2 n ) = \{ \begin{matrix}{s}_{0}^{( {m}_{0} )} ( n ) {c}_{0} ( n ) & in subframe 0 \\ {s}_{1}^{( {m}_{1} )} ( n ) {c}_{0} ( n ) & in subframe 5\end{matrix} \\ d ( 2 n + 1 ) = \{ \begin{matrix}{s}_{1}^{( {m}_{1} )} ( n ) {c}_{1} ( n ) {z}_{1}^{( {m}_{0} )} ( n ) & in subframe 0 \\ {s}_{0}^{( {m}_{0} )} ( n ) {c}_{1} ( n ) {z}_{1}^{( {m}_{1} )} ( n ) & in subframe 5\end{matrix} \qquad [ Equation 2 ]$$

Here, indices m₀ and m₁ are generated from the PCID group, and the result may be as illustrated in Table 3 below.

$${m}_{0} = {m}^{′} mod 31 \\ {m}_{1} = ( {m}_{0} + ⌊ {m}^{′} / 31 ⌋ + 1 ) mod 31 \\ {m}^{′} = {N}_{ID}^{( 1 )} + q ( q + 1 ) / 2 , \\ q = ⌊ \frac{{N}_{ID}^{( 1 )} + {q}^{′} ( {q}^{′} + 1 ) / 2}{30} ⌋ , {q}^{′} = ⌊ {N}_{ID}^{( 1 )} / 30 ⌋ \qquad [ Equation 3 ]$$

Two sequences Sequence S₀^{(m}^{₀}⁾(n) and S₁^{(m}^{₁}⁾(n) are defined as two different cyclic shifts of M-Sequence \tilde{s}(n), and \tilde{s}(n)=1−2x(i) is defined by Equation (4) below. (0≤i≤30)

s₀^{(m}^{₀}⁾(n)=\tilde{s}((n+m₀)mod 31)

s₁^{(m}^{₁}⁾(n)=\tilde{s}((n+m₁)mod 31)

x(ī+5)=(x(ī+2)+x(ī))mod 2, 0≤ī≤25 [Equation 4]

The initial conditions are x(0)=0, x(1)=0, x(2)=0, x(3)=0, x(4)=1.

Meanwhile, two scrambling sequences c₀(n) and c₁(n) are dependent on the primary synchronization signal and are defined by two different cyclic shifts of the M-Sequence \tilde{c}(n).

c₀(n)=\tilde{c}((n+N_{ID}⁽²⁾)mod 31)

c₁(n)=\tilde{c}((n+N_{ID}⁽²⁾+3)mod 31) [Equation 5]

Here, N_{ID}⁽²⁾∈{0,1,2} is a PCID of PCID Group N_{ID}⁽¹⁾, and \tilde{c}(i)=1−2x(i) is defined by Equation 6 below. (0≤i≤30)

x(ī+5)=(x(ī+3)+x(ī))mod 2, 0≤ī≤25 [Equation 6]

Here, initial conditions are x(0)=0, x(1)=0, x(2)=0, x(3)=0, x(4)=1.

Meanwhile, the scrambling sequences z₀^{(m}^{₀}⁾(n) and z₁^{(m}^{₁}⁾(n) are defined by a cyclic shift of M-Sequence \tilde{z}(i), m₀ and m₁ are obtained from Table 3 below, and \tilde{z}(i)=1−2x(i), 0≤i≤30 is defined by Equation 7 below.

z₀^{(m}^{₀}⁾(n)=\tilde{z}((n+(m₀ mod 8))mod 31)

z₁^{(m}^{₁}⁾(n)=\tilde{z}((n+(m₁ mod 8))mod 31)

x(ī+5)=(x(ī+4)+x(ī+2)+x(ī+1)+x(ī)mod 2, 0≤ī≤25 [Equation 7]

Here, initial conditions are x(0)=0, x(1)=0, x(2)=0, x(3)=0, x(4)=1.

To sum up, in the LTE/LTE-A system, the number of PCIDs is defined as 504, including a combination of PSS code sequence and SSS code sequence, and the PSS and SSS are transmitted to UEs by 6 RBs.

Cell search defined in LTE/LTE-A refers to a procedure in which a UE obtains time synchronization and frequency synchronization for one cell and identifies a physical cell ID of a specific cell.

That is, the E-UTRA cell search is based on PSS/SSS transmitted to the DL, which is also applied to neighbor cell search for measurement in the case of handover.

However, considering a moving cell anticipated to be accommodated in the 5G wireless communication environment, once the UE get on a bus, a train, or a smart car, the UE may recognize the corresponding bus, train, smart car, and the like, as a serving cell (node) thereof may exchange DL/UL control signal or DL/UL data through bus, train, or smart car.

This environment is different from fixed small cell-based communication which has been considered in the conventional 4G wireless communication environment. In the case of bus, train, and smart car, reliability and delay of a communication service are considered to be more important issues because a plurality of UEs must be simultaneously served. That is, in order to realize communication through a moving cell, the moving cell must provide high quality service to the users transparently in accordance with a change in an environment according to movement thereof.

This means that, in a neighbor cell search for measurement at the time of handover in the 4G wireless communication environment, the moving cell detecting and measuring other access link-oriented neighboring moving cells rather than the backhaul link-oriented fixed BSs, may cause unnecessary measurement overhead of the moving cell, which is problematic. Therefore, from the viewpoint of moving cell, it is necessary to detect an access link of neighboring moving cells and not measure it at the time of handover to prevent “undesired HO” that may unnecessarily occur.

TABLE 3

| N_{ID}⁽¹⁾ | m₀ | m₁ |
|---|---|---|
| 0 | 0 | 1 |
| 1 | 1 | 2 |
| 2 | 2 | 3 |
| 3 | 3 | 4 |
| 4 | 4 | 5 |
| 5 | 5 | 6 |
| 6 | 6 | 7 |
| 7 | 7 | 8 |
| 8 | 8 | 9 |
| 9 | 9 | 10 |
| 10 | 10 | 11 |
| 11 | 11 | 12 |
| 12 | 12 | 13 |
| 13 | 13 | 14 |
| 14 | 14 | 15 |
| 15 | 15 | 16 |
| 16 | 16 | 17 |
| 17 | 17 | 18 |
| 18 | 18 | 19 |
| 19 | 19 | 20 |
| 20 | 20 | 21 |
| 21 | 21 | 22 |
| 22 | 22 | 23 |
| 23 | 23 | 24 |
| 24 | 24 | 25 |
| 25 | 25 | 26 |
| 26 | 26 | 27 |
| 27 | 27 | 28 |
| 28 | 28 | 29 |
| 29 | 29 | 30 |
| 30 | 0 | 2 |
| 31 | 1 | 3 |
| 32 | 2 | 4 |
| 33 | 3 | 5 |
| 34 | 4 | 6 |
| 35 | 5 | 7 |
| 36 | 6 | 8 |
| 37 | 7 | 9 |
| 38 | 8 | 10 |
| 39 | 9 | 11 |
| 40 | 10 | 12 |
| 41 | 11 | 13 |
| 42 | 12 | 14 |
| 43 | 13 | 15 |
| 44 | 14 | 16 |
| 45 | 15 | 17 |
| 46 | 16 | 18 |
| 47 | 17 | 19 |
| 48 | 18 | 20 |
| 49 | 19 | 21 |
| 50 | 20 | 22 |
| 51 | 21 | 23 |
| 52 | 22 | 24 |
| 53 | 23 | 25 |
| 54 | 24 | 26 |
| 55 | 25 | 27 |
| 56 | 26 | 28 |
| 57 | 27 | 29 |
| 58 | 28 | 30 |
| 59 | 0 | 3 |
| 60 | 1 | 4 |
| 61 | 2 | 5 |
| 62 | 3 | 6 |
| 63 | 4 | 7 |
| 64 | 5 | 8 |
| 65 | 6 | 9 |
| 66 | 7 | 10 |
| 67 | 8 | 11 |
| 68 | 9 | 12 |
| 69 | 10 | 13 |
| 70 | 11 | 14 |
| 71 | 12 | 15 |
| 72 | 13 | 16 |
| 73 | 14 | 17 |
| 74 | 15 | 18 |
| 75 | 16 | 19 |
| 76 | 17 | 20 |
| 77 | 18 | 21 |
| 78 | 19 | 22 |
| 79 | 20 | 23 |
| 80 | 21 | 24 |
| 81 | 22 | 25 |
| 82 | 23 | 26 |
| 83 | 24 | 27 |
| 84 | 25 | 28 |
| 85 | 26 | 29 |
| 86 | 27 | 30 |
| 87 | 0 | 4 |
| 88 | 1 | 5 |
| 89 | 2 | 6 |
| 90 | 3 | 7 |
| 91 | 4 | 8 |
| 92 | 5 | 9 |
| 93 | 6 | 10 |
| 94 | 7 | 11 |
| 95 | 8 | 12 |
| 96 | 9 | 13 |
| 97 | 10 | 14 |
| 98 | 11 | 15 |
| 99 | 12 | 16 |
| 100 | 13 | 17 |
| 101 | 14 | 18 |
| 102 | 15 | 19 |
| 103 | 16 | 20 |
| 104 | 17 | 21 |
| 105 | 18 | 22 |
| 106 | 19 | 23 |
| 107 | 20 | 24 |
| 108 | 21 | 25 |
| 109 | 22 | 26 |
| 110 | 23 | 27 |
| 111 | 24 | 28 |
| 112 | 25 | 29 |
| 113 | 26 | 30 |
| 114 | 0 | 5 |
| 115 | 1 | 6 |
| 116 | 2 | 7 |
| 117 | 3 | 8 |
| 118 | 4 | 9 |
| 119 | 5 | 10 |
| 120 | 6 | 11 |
| 121 | 7 | 12 |
| 122 | 8 | 13 |
| 123 | 9 | 14 |
| 124 | 10 | 15 |
| 125 | 11 | 16 |
| 126 | 12 | 17 |
| 127 | 13 | 18 |
| 128 | 14 | 19 |
| 129 | 15 | 20 |
| 130 | 16 | 21 |
| 131 | 17 | 22 |
| 132 | 18 | 23 |
| 133 | 19 | 24 |
| 134 | 20 | 25 |
| 135 | 21 | 26 |
| 136 | 22 | 27 |
| 137 | 23 | 28 |
| 138 | 24 | 29 |
| 139 | 25 | 30 |
| 140 | 0 | 6 |
| 141 | 1 | 7 |
| 142 | 2 | 8 |
| 143 | 3 | 9 |
| 144 | 4 | 10 |
| 145 | 5 | 11 |
| 146 | 6 | 12 |
| 147 | 7 | 13 |
| 148 | 8 | 14 |
| 149 | 9 | 15 |
| 150 | 10 | 16 |
| 151 | 11 | 17 |
| 152 | 12 | 18 |
| 153 | 13 | 19 |
| 154 | 14 | 20 |
| 155 | 15 | 21 |
| 156 | 16 | 22 |
| 157 | 17 | 23 |
| 158 | 18 | 24 |
| 159 | 19 | 25 |
| 160 | 20 | 26 |
| 161 | 21 | 27 |
| 162 | 22 | 28 |
| 163 | 23 | 29 |
| 164 | 24 | 30 |
| 165 | 0 | 7 |
| 166 | 1 | 8 |
| 167 | 2 | 9 |
| — | — | — |
| — | — | — |

In the operation of the UE and the BS as described above, a problem predicted by operating the moving cell as illustrated in FIG. 2 is that movement of the moving cell between the congested heterogeneous networks may affect measurement of channel quality such as MUE, PUE, and FUE to cause the existing BSs to perform unnecessary handover to the moving cell.

For example, when the moving cell moves to a path as illustrated in FIG. 2, a MUE that has received a service through a macro cell may attempt handover to the moving cell, but at the time when the corresponding MUE attempts handover, the moving cell may already have passed the position of the MUE.

In addition, in the moving cell supporting environment, the moving cell may be connected to a fixed BS as if it is a terminal and provides a service to UEs in the moving cell, and thus, the moving cell itself also needs to perform a handover procedure. To this end, the moving cell (first moving cell) may perform channel measurement on neighboring cell signals to search for a handover target. However, if there is another moving cell (second moving cell) in a congested heterogeneous network environment, the first moving cell may determine handover through a second moving cell signal search to attempt unnecessary handover.

In order to solve this problem, a method of transmitting a synchronization signal for a moving cell in a frequency domain different from a synchronization signal for a legacy UE in order to minimize the influence of the moving cell BS on cell search of the legacy UE will be described.

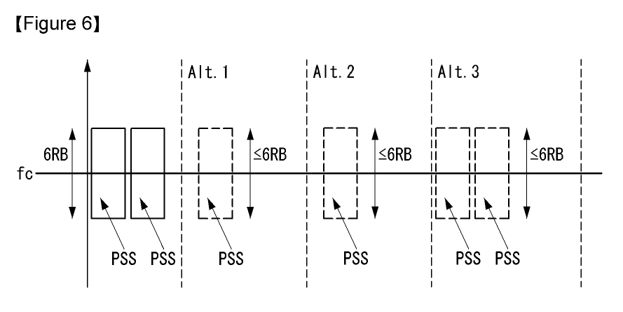

FIG. 6 is a view illustrating that a synchronization signal for a moving cell is transmitted in a frequency domain different from that of a legacy synchronization signal.

As illustrated on the leftmost side of FIG. 6, a synchronization signal in the LTE/LTE-A system includes a primary synchronization signal (PSS) and a secondary synchronization signal (SSS), and the synchronization signal is mapped to an area having a 6 RB (resource block) length based on a DC component and is then transmitted through the carrier frequency fc.

Based on this, in an embodiment of the present invention, in order to transmit a synchronization signal for a moving cell in a frequency domain different from a synchronization signal for a legacy UE according to an embodiment of the present invention, (1) only a PSS configured for a moving cell may be transmitted in a frequency domain having a length of 6RB or less (Alt. 1 in FIG. 6), (2) only the SSS configured for the moving cell may be transmitted in the frequency domain having a length of 6RB or less (Alt. 2 in FIG. 6), or (3) the PSS and the SSS configured for the moving cell may be transmitted in the frequency domain (Alt. 3 in FIG. 6).

Meanwhile, in FIG. 6, it is assumed that the synchronization signal for the moving cell is also transmitted through a position symmetric based on the carrier frequency fc, but the present invention is not limited thereto.

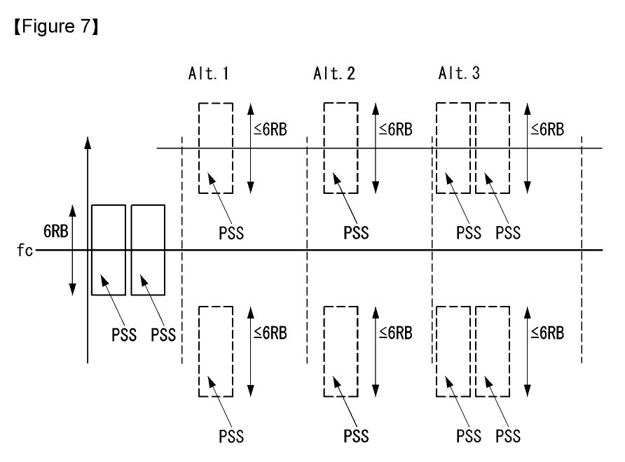

FIG. 7 is a view illustrating that a synchronization signal for a moving cell is transmitted in a frequency domain different from that of a legacy synchronization signal.

Specifically, in the embodiment illustrated in FIG. 7, an example is illustrated in which a synchronization signal for a moving cell is mapped to a position shifted by n in a positive (+) direction and/or by n in a negative (−) direction about a carrier and transmitted. The size of n needs not be limited and may have a range of—(system bandwidth/2)≤n≤(system bandwidth/2).

Also, in the example of FIG. 7, the synchronization signal sequence for each moving cell may be mapped to a frequency domain having a length of 6RB or less and transmitted. Alternatively, only the PSS of the moving cell synchronization signal configured for the moving cell may be transmitted in the frequency domain having a length of 6RB or less in a position away by (1)±n from (Alt. 1 in FIG. 7), 2) only the SSS configured for the moving cell may be transmitted in the frequency domain having a length of 6RB or less in a position away by ±n (Alt. 2 in FIG. 7), or (3) the PSS and the SSS configured for the moving cell may be transmitted in the frequency domain having a length of 6RB or less in a position away by ±n (Alt. 2 in FIG. 7).

The synchronization signal for the moving cell transmitted in FIGS. 6 and 7 may be a signal transmitted in addition to the synchronization signal of the legacy system.

The additionally transmitted signal may be the PSS, the SSS, or a combination of PSS and SSS as illustrated in FIGS. 6 and 7, or may be a newly defined moving cell sequence.

In FIGS. 6 and 7 described above, the 5G UE recognizes the moving cell through detection of a new synchronization signal or recognizes the moving cell by detecting an existing PSS/SSS (dedicatedly allocated for the moving cell).

However, considering the methods of FIGS. 6 and 7, the legacy UE may not be able to determine whether it is a legacy cell or a moving cell.

Therefore, the legacy UE may perform network access by misrecognizing the moving cell as a legacy cell, and thus, the present disclosure provides a method for preventing the problem.

Hereinafter, a method of preventing a legacy UE from accessing a moving cell by introducing a new PCID (Physical Cell ID) for a moving cell in the 5G wireless communication environment proposed in this disclosure will be described in detail with reference to each embodiment.

First, problems that may arise when the legacy UE accesses a moving cell will be briefly described.

It is assumed that the moving cell A and the moving cell B have the same legacy primary synchronization signal PSS and secondary synchronization signal SSS and each of the moving cells A and B has different new synchronization signals (NSSs).

First, if the moving cell A and the moving cell B are adjacent to each other, the legacy UE may not be able to distinguish between the moving cell A and the moving cell B.

Second, if another moving cell B is approaching, the legacy UE within the coverage of the moving cell A (or present in the moving cell A), the legacy UE recognizes the moving cell A and the moving cell B as the same cell.

In other words, if the legacy UE accesses the moving cell, the foregoing two problems arise, and thus, in order to prevent this, a method for preventing the legacy UE from accessing the moving cell is required.

### First Embodiment

The first embodiment provides a method for preventing a legacy UE from accessing a moving cell proposed in the present invention by recycling a CSG ID (Closed Subscriber Group Identity) and a CSG indication of an LTE (-A) system.

The CSG cell is a cell for providing a service only to the CSG group, and refers to a cell for supporting a better service for the CSG member terminals.

Each CSG has a CSG ID corresponding to a unique identification number.

Also, the CSG indicator (Indication) is an indicator for indicating whether the cell is a CSG cell or not.

The first embodiment provides a method in which the BS transmits system information (for example, SIB 1) including the CSG ID and the CSG indication in the same manner as in the related art but the legacy UE and the 5G UE are defined to differently interpret the system information to operate, whereby the legacy UE is prevented to access a moving cell, while the 5G UE accesses the moving cell.

The CSG cell may include a CSG (femto) cell, a moving cell, and the like.

The CSG cells are each identified by a unique numeric identifier called CSG ID.

In addition, a terminal subscribed to a specific CSG has a CSG ID for a CSG subscribed to a CSG whitelist (Whitelist) retained by the terminal.

The CSG Whitelist is provided to the UE by NAS (Non-Access Stratum), and the UE maintains the CSG Whitelist.

In addition, each CSG cell broadcasts a CSG ID through system information (SI).

Also, the UE uses the CSG ID for a cell (re)selection procedure or for a handover purpose.

Next, an operation method of each UE in case where the legacy UE and the 5G UE receive system information (SI) including the CSG ID and the CSG indication will be described.

It is assumed that the BS allocates some of the CSG IDs to a moving cell ID for the purpose of identifying a moving cell.

Also, it is assumed that the BS allocates the moving cell ID only to the 5G UE without allocating the moving cell ID to the legacy UE.

This means that the CSG ID to which an MCID is mapped is not allocated to the legacy UE and the CSG ID to which the MCID is mapped is allocated to the 5G UE.

When the legacy UE receives the system information including the parameters illustrated in Table 4 below, the CSG ID (CSG ID mapped to the moving cell ID) included in the received system information is not included in the CSG Whitelist (I.e., the legacy UE has not been allocated the CSG ID associated with (or corresponding to) the moving cell from the BS), and thus, the legacy UE cannot access the moving cell.

Specifically, the BS generates some of the CSG IDs for the moving cell, sets a CSG-Indication corresponding to the CSG IDs to ‘true’, and transmits (or informs) the CSG-Indication to the UEs (legacy UE and 5G UE) within the moving cell through the system information (e.g., SIB 1).

Here, the moving cells do not allocate the CSG ID for identifying the moving cells (or the CSG ID for the moving cells) to the legacy UEs, and by setting the CSG indication to ‘true’, the moving cells may prevent the legacy UEs from accessing the moving cells.

Therefore, upon receiving the SIB 1 including the CSG ID and the CSG indication related to the moving cells, the legacy UEs may recognize that the corresponding moving cell is not an open cell (or normal cell) through the CSG Indication related to the moving cell, and upon checking that the CSG ID related to the moving cell is not included in the CSG whitelist retained by the legacy HEs, the legacy UEs do not access the moving cell.

That is, in the first embodiment, the legacy UE does not access the moving cell through reception of SIB 1, without separately having to distinguish between a femtocell and a moving cell.

Table 4 below illustrates an example of the SIB 1 format including the CSG ID and the CSG indication field according to the first embodiment.

TABLE 4
--ASN1START
SystemInformationBlockType1 ::= SEQUENCE {
cellAccessRelatedInfo SEQUENCE {
plmn-IdentityList PLMN-IdentityList,
trackingAreaCode TrackingAreaCode,
cellIdentity CellIdentity,
cell BarredENUMERATED {barred, notBarred},
intraFreqReselection ENUMERATED {allowed, notAllowed},
csg-Indication BOOLEAN,
csg-Identity CSG-Identity OPTIONAL-- Need OR
},
cellSelectionInfo SEQUENCE {
q-RxLevMin Q-RxLevMin,
q-RxLevMinOffset INTEGER (1..8) OPTIONAL-- Need OP
},
p-Max P-Max OPTIONAL, -- Need OP
freqBandIndicator FreqBandIndicator,
schedulingInfoList SchedulingInfoList,
tdd-Config TDD-Config OPTIONAL,-- Cond TDD
si-WindowLength ENUMERATED {
ms1, ms2, ms5, ms10, ms15, ms20,
ms40},
systemInfoValueTag INTEGER (0..31),
nonCriticalExtension SystemInformationBlockType1-v890-
IEsOPTIONAL-- Need OP
}
SystemInformationBlockType1-v890-IEs::=SEQUENCE {
lateNonCriticalExtension OCTET STRING (CONTAINING
SystemInformationBlockType1-v8h0-IEs) OPTIONAL,-- Need OP
nonCriticalExtension SystemInformationBlockType1-v920-
IEsOPTIONAL-- Need OP
}
-- Late non critical extensions
SystemInformationBlockType1-v8h0-IEs ::=SEQUENCE {
multiBandInfoList MultiBandInfoList OPTIONAL,-- Need OR
nonCriticalExtension SystemInformationBlockTypel-v9e0-IEsOPTIONAL--
Need OP
}
SystemInformationBlockType1-v9e0-IEs ::= SEQUENCE {
freqBandIndicator-v9e0 FreqBandIndicator-v9e0 OPTIONAL,--
Cond FBI-max
multiBandInfoList-v9e0 MultiBandInfoList-v9e0 OPTIONAL,--
Cond mFBI-max
nonCriticalExtension SEQUENCE { } OPTIONAL-- Need OP
}
-- Regular non critical extensions
SystemInformationBlockType1-v920-IEs ::=SEQUENCE {
ims-EmergencySupport-r9 ENUMERATED {true} OPTIONAL,--
Need OR
cellSelectionInfo-v920 CellSelectionInfo-v920 OPTIONAL,-- Cond RSRQ
nonCriticalExtension SystemInformationBlockType1-v1130-
IEsOPTIONAL-- NeedOP
}
SystemInformationBlockType1-v1130-IEs ::=SEQUENCE {
tdd-Config-v1130 TDD-Config-v1130 OPTIONAL,-- Cond TDD-OR
cellSelectionInfo-v1130 CellSelectionInfo-v1130 OPTIONAL,--
Cond WB-RSRQ
nonCriticalExtension SEQUENCE { } OPTIONAL-- Need OP
}
PLMN-IdentityList ::= SEQUENCE (SIZE (1..maxPLMN-r11)) OF
PLMN-IdentityInfo
PLMN-IdentityInfo ::= SEQUENCE {
plmn-Identity PLMN-Identity,
cellReservedForOperatorUse ENUMERATED {reserved, notReserved}
}
SchedulingInfoList ::= SEQUENCE (SIZE (1 ..maxSI-Message))
OF SchedulingInfo
SchedulingInfo ::=SEQUENCE {
si-Periodicity ENUMERATED {
rf8, rf16, rf32, rf64, rf128, rf256, rf512},
sib-MappingInfo SIB-MappingInfo
}
SIB-MappingInfo ::= SEQUENCE (SIZE (0..maxSIB-1)) OF SIB-Type
SIB-Type ::= ENUMERATED {
sibType3, sibType4, sibType5, sibType6,
sibType7, sibType8, sibType9, sibType10,
sibType11, sibType12-v920, sibType13-v920,
sibType14-v1130, sibType15-v1130,
sibType16-v1130, spare2, spare1, ...}
CellSelectionInfo-v920 ::= SEQUENCE {
q-QualMin-r9 Q-QualMin-r9,
q-QualMinOffset-r9 INTEGER (1..8) OPTIONAL-- Need OP
}
CellSelectionInfo-v1130 ::= SEQUENCE {
q-QualMinWB-r11 Q-QualMin-r9
}
-- ASN1STOP

### Second Embodiment

The second embodiment provides a method of defining a moving cell ID (MCID) separately and preventing a legacy UE from accessing a moving cell through a mapping relationship between a CSG ID and an MCID.

The second embodiment may be performed through the following two methods.

That is, the second embodiment may be divided into (1) a method of preventing a legacy UE from accessing a moving cell by defining an MCID and a mapping relationship between a CSG ID and the MCID, and (2) a method of preventing a legacy UE from access a moving cell by defining an MCID, a moving cell indication corresponding to the MCID, and a mapping relationship between a CSG ID and the MCID.

As discussed above, the CSG indication (field) refers to information indicating whether a cell is a CSG cell or a normal cell (or open cell).

The system information (e.g., SIB 1) proposed in this disclosure may include a CSG ID, a CSG Indication, a MCID, a moving cell Indication corresponding to the MCID, mapping information between the CSG ID and the MCID, and the like.

Here, the MCID may be defined as a part of the CSG IDs, or may be newly defined separately from the CSG IDs.

Here, the mapping information (or information related to the mapping relationship) between the CSG ID and the MCID may be transmitted to UEs (within the moving cell) through separate system information (SI) or a separate message distinguished from system information including a CSG ID, a CSG indication, and the like.

Here, the separate system information may refer to dedicated system information (SI) for the moving cell.

First, the first method of the second embodiment will be described in detail.

It is assumed that the mapping relationship between the CSG ID and the MCID is defined in advance and transmitted to the UEs

The moving cell IDs (MCIDs) may be grouped and mapped to the CSG IDs.

For example, the entire MCIDs may be grouped into one group and mapped to one CSG ID.

In another example, the MCIDs may be grouped to N groups, and the N number of groups of the MCIDs may be mapped to N number of CSG IDs in a one-to-one manner.

Here, the BS does not allocate a CSG set to be in a mapping relationship with the MCID to the legacy UE.

Meanwhile, the BS allocates a CSG ID set to be in a mapping relationship with the MCID to the 5G UE.

In this manner, the MCID is defined and the legacy UE is prevented from accessing the moving cell through the mapping relationship between the CSG ID and the MCID.

That is, since the legacy UE cannot receive the CSG ID having a mapping relationship with the MCID from the BS, the legacy UE is fundamentally prevented from accessing the moving cell.

To sum up, the legacy UE receives system information including the CSG ID, the CSG indication, the MCID, and the mapping information between the CSG ID and the MCID from the BS.

Thereafter, if the CSG ID corresponding to the CSG indication set to ‘true’ is a CSG ID that is not held by the legacy UE, the legacy UE does not access the corresponding cell.

As discussed above, the legacy UE retains (or holds) the CSG Whitelist with the CSG ID in advance.

Meanwhile, the 5G UE determines whether the CSG ID corresponding to the CSG indication set to ‘true’ is the same as the CSG ID held by itself.

If it is determined that the CSG ID corresponding to the CSG indication set to ‘true’ is equal to the CSG ID held by the 5G UE, the 5G UE checks a mapping relationship between the CSG ID and the MCID through information of the mapping relationship between the CSG ID and the MCID.

If it is determined that the mapping relationship is set between the CSG ID and the MCID, the 5G UE recognizes the MCID information and performs an access procedure with the moving cell through detection of the recognized MCID.

Next, the second method of the second embodiment will be described.

The second method of the second embodiment is a method of preventing a legacy UE from accessing a moving cell by additionally defining a moving cell ID and a moving cell indication field corresponding thereto.

The system information (e.g., SIB 1) proposed in the present disclosure may include a CSG ID, a CSG indication, an MCID, a moving cell indication field, mapping information between a CSG ID and an MCID, and the like.

Here, the mapping information between the CSG ID and the MCID may be transmitted separately from the system information including the CSG ID and the CSG Indication such as dedicated system information for the moving cell, or may be transmitted to the UE through another message, or the like.

The moving cell indication field refers to information indicating whether access to a moving cell is allowed or information indicating whether the cell is a moving cell.

Also, in the second method of the second embodiment, the mapping relationship between the CSG ID and the MCID may be set (or defined) in advance.

That is, the legacy UE determines whether a received CSG ID matches the CSG ID of the CSG cell (e.g., CSG femtocell) to which the legacy UE has subscribed on the basis of the CSG ID and the CSG indication received through the system information (e.g., SIB 1).

According to the result of the determination, the legacy UE determines whether to access the corresponding CSG cell.

If it is determined that the received CSG ID does not match the CSG ID held by the legacy UE, the legacy UE does not access the CSG cell including the moving cell.

Also, although the received CSG ID matches the CSG ID held by the legacy UE, if the mapping relationship is set between the received CSG ID and the MCID (through the information on the mapping relationship between the CSG ID and the MCID), the legacy UE does not access the CSG cell (including the moving cell) corresponding to the received CSG ID.

Meanwhile, the 5G UE determines whether the 5G UE may access the moving cell through the CSG ID, the CSG indication, the MCID, the moving cell indication, and the mapping information between the CSG ID and the MCID included in the system information (e.g., SIB 1).

First, the 5G UE determines whether the received CSG ID matches the CSG ID held by the 5G UE through the received CSG ID and the CSG indication, and determines whether to access the CSG cell including the moving cell.

Specifically, when the received CSG ID matches the CSG ID held by the 5G UE, the 5G UE checks a mapping relationship between the CSG ID and the MCID, a moving cell indication, and the like.

Here, if the moving cell indication corresponding to each MCID in a mapping relationship with the received CSG ID indicates permission for accessing the moving cell, the 5G UE performs an access procedure with the moving cell corresponding to each MCID through detection of each MCID.

As described above, through the mapping relationship between the CSG ID and the MCID, the moving cell indication, and the like, the legacy UE is not allowed to access the moving cell, while the 5G UE is allowed to access the moving cell.

Table 5 below shows an example of a system information (e.g., SIB 1) format including a moving cell ID (MCID) and a moving cell indication field proposed in the present disclosure.

That is, by transmitting system information including information of Table 5 below to UEs (legacy UE and 5G UE) such that a specific moving cell may be viewed as a CSG (femto) cell, legacy UEs cannot access moving cells and the 5G UE can access the moving cell.

TABLE 5

| SIB1 IE | Normal Cell | Moving Cell |
|---|---|---|
| csg-Indication | FALSE | TRUE |
| csg-Identity | Absent | Present (ID allocated for Moving Cell) |

In Table 5, the csg-Indication field related to the moving cell may be represented as a moving cell indication, and the csg-Identity related to the moving cell may be represented as a moving cell ID.

Also, a normal cell may refer to an open cell, not a CSG cell including a moving cell.

### Third Embodiment

The third embodiment provides a method of preventing a legacy UE from accessing a moving cell by newly defining a PCID (Physical Cell ID) for a moving cell.

The third embodiment provides a method of scrambling (1) a physical broadcast channel (PBCH) for transmitting a MIB (Master Information Block) and (2) a physical control format indicator channel (PCFICH) for transmitting a CFI (Control Format Indicator) to a new PCID and transmitting the same to a UE in the LTE/LTE-A system.

The new PCID indicates a physical layer identifier for identifying a moving cell.

That is, as the legacy UE fails to detect the PBCH and the PCFICH scrambled to the new PCID, the legacy UE cannot access a moving cell.

Hereinafter, a method of defining a new PCID of a moving cell proposed in this disclosure will be described in detail on the basis of the contents related to the synchronization signal (or the PCID allocation method) defined in the LTE/LTE-A system and the new synchronization signal (NSS) for supporting a moving cell will be described in detail.

The NSS may also be expressed as a moving cell synchronization signal (MSS).

Unlike the PCID mapping method defined in Equation 1, the PCID for the moving cell is newly defined by Equation 8 below using a PSS and the NSS (New Synchronization Signal), excluding an SSS.

N_{ID}^{Cell}=3N_{ID}⁽³⁾+N_{ID}⁽²⁾ [Equation 8]

Here, the NSS is set to a value different from the SSS so that the legacy UE cannot access the moving cell.

Since the NSS is transmitted only once, there is a high possibility that the NSS is detected incorrectly, relative to the SSS.

Therefore, preferably, the NSS value may be associated to the SSS so that the UE may accurately detect the NSS based on the SSS value.

For example, if the NSS value that may follow one SSS is limited to one, the moving cell ID (MCID) totals 504.

Therefore, the ID of the NSS mapped to the SSS may be set to N_{ID}⁽³⁾=(N_{ID}⁽²⁾+x)mod 167. Here, x is an arbitrary integer.

Also, preferably, x is set to “84’ in consideration of the characteristics of a sequence in which a difference is increased as the start value is different.

In another example, if the NSS value that may follow one SSS is limited to two, the moving cell ID may total 1,008.

In this case, the ID of the NSS that may be mapped to the SSS may be set to N_{ID}⁽³⁾=(N_{ID}⁽²⁾+x_1)mod 167 or N_{ID}⁽³⁾=(N_{ID}⁽²⁾+x_2)mod 167. Here, x_1 and x_2 may be arbitrary integers.

In order to distribute the moving cell IDs to the maximum level, x_1 may be set to ‘56’ and x_2 may be set to ‘112’.

In the case of generalization, when the number of NSS that may be mapped to the SSS is N, the moving cell ID may be a maximum of 504*N.

In this case, when the SSS is N_{ID}⁽²⁾, the NSS value may be set to N_{ID}⁽³⁾=(N_{ID}⁽²⁾+x_n)mod 167. n=1, 2, 3, . . . , N.

Here, x_n indicates Ceil(168/(N+1))*n.

Here, N_{ID}⁽¹⁾ is the SSS, and the SSS has a value ranging from 0 to 167.

Also, N_{ID}⁽²⁾ is the PSS, and the PSS has a value ranging from 0 to 2.

Also, N_{ID}⁽³⁾ indicates the NSS, and NSS has a value ranging from 0 to 167 like the SSS.

That is, the legacy UE may decode information such as MIB and CFI transmitted from a legacy ordinary cell, not a moving cell, using a PCID corresponding to the cell.

However, the legacy UE cannot decode information such as MIB and CFI transmitted from the moving cell. This is because the information such as the MIB and the CFI transmitted from the moving cell is scrambled to the newly defined new PCID and transmitted.

Therefore, since the legacy UE cannot receive the PBCH, PCFICH, and the like, transmitted from the moving cell, the legacy UE cannot access the moving cell.

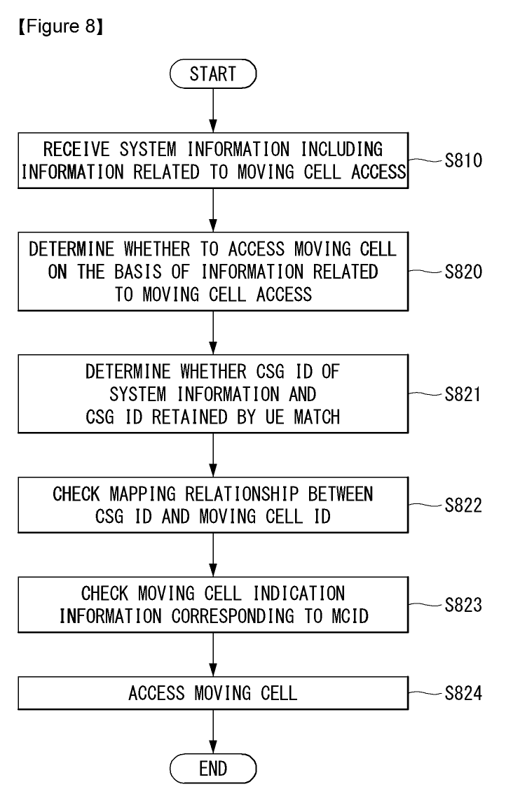

FIG. 8 is a flowchart illustrating an example of a method of performing an access procedure with a moving cell proposed in the present disclosure.

First, a UE receives system information (SI) including information related to a moving cell access from a BS (S810).

The information related to the moving cell access may include at least one of CSG (Closed Subscriber Group) indication information indicating whether the cell is a CSG cell or a normal cell, a CSG ID (Identity) for identifying a CSG cell, a moving cell ID (MCID) for identifying a moving cell, and moving cell indication information indicating accessibility to a moving cell ID.

In addition, the information related to the moving cell access may further include mapping information between the CSG ID and the MCID.

Here, the UE includes both a legacy UE and a 5G UE.

Thereafter, the UE determines whether to access the moving cell on the basis of the information related to the moving cell access (S820).

Hereinafter, step S820 will be described in more detail.

That is, the UE determines whether the CSG ID included in the system information is present in a CSG whitelist retained by the UE (S821).

If it is determined in step S821 that the CSG ID included in the system information is not present in the CSG whitelist, the UE does not access the moving cell.

In the case of step S821, both the legacy UE and the 5G UE do not access the moving cell.

If it is determined in step S821 that the CSG ID included in the system information is present in the CSG whitelist, the UE determines whether the CSG ID included in the system information is mapped to the MCID included in the system information (S822).

When the CSG ID included in the system information is mapped to the MCID included in the system information in step S822, the legacy UE does not access the moving cell.

Meanwhile, when the CSG ID included in the system information is mapped to the MCID included in the system information in step S822, the 5G UE additionally checks the moving cell indication information corresponding to the MCI D (S823).

Thereafter, the 5G UE determines whether to access the moving cell based on the result of the checking in step S823.

If the moving cell indication information indicates permission for accessing the moving cell, the 5G UE performs an access procedure with respect to the moving cell through the MCID detection (S824).

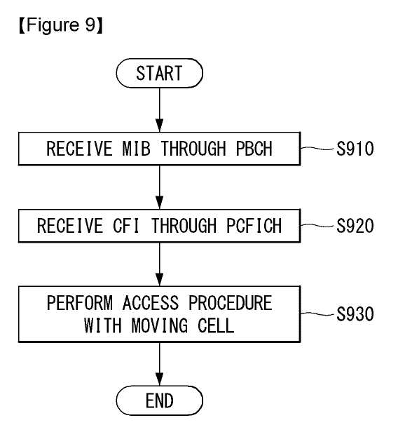

FIG. 9 is a flowchart showing another example of a method of performing a connection procedure with a moving cell proposed in this disclosure.

First, a UE receives a master information block (MIB) from a BS through a physical broadcast channel (PBCH) (S910).

Thereafter, the UE receives a control format indicator (CFI) from the BS through a physical control format indicator channel (PCFICH) (S920).

Here, the MIB and the CFI include information related to a moving cell access, and the PBCH and the PCFICH are scrambled to a physical cell identity (PCID) of a moving cell.

The physical layer cell ID of the moving cell may be determined using at least one of an ID of a primary synchronization signal (PSS), an ID of a secondary synchronization signal (SSS), and an ID of a new synchronization signal (NSS).

Particularly, the physical layer cell ID of the moving cell may be determined by N_{ID}^{Cell}=3N_{ID}⁽³⁾+N_{ID}⁽²⁾. Here, N_{ID}⁽²⁾ represents the ID of the SSS, and N_{ID}⁽³⁾ represents the ID of the NSS.

Also, the ID of the NSS may be determined by NN_{ID}⁽³⁾=(N_{ID}⁽²⁾+x_n)mod 167.

Thereafter, the UE performs an access procedure with the moving cell based on the received MIB and CFI (S930).

Steps S910 to S930 are performed only by the 5G UE, and the legacy UE cannot perform steps S910 to S930 because it does not have capability of detecting the PCID of the moving cell.

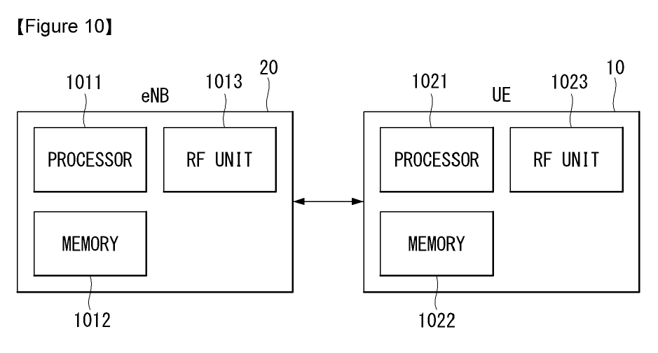

FIG. 10 is a block view illustrating a wireless device in which the methods proposed herein may be implemented.

Here, the wireless device may be a network entity, a BS, a terminal, and the like, and the BS includes both a macro BS and a small BS.

As illustrated in FIG. 10, the BS (or an eNB) 20 and the UE 10 include a communication units (transceiver unit and an RF unit) 1013 and 1023, processors 1011 and 1021, and memories 1012 and 1022.

The BS and the UE may further include an input unit and an output unit.

The communication units 1013 and 1023, the processors 1011 and 1021, the input unit, the output unit, and the memories 1012 and 1022 are functionally connected to perform the method proposed in this disclosure.

Upon receiving information created from a PHY protocol (Physical Layer Protocol), the communication unit (transceiver unit or RF unit) 1013 or 1023 transfers the received information to an RF spectrum, performs filtering, amplification, and the like, on the information, and transmits the same to an antenna. In addition, the communication unit moves a radio frequency (RF) signal received from the antenna to a band that may be processed by the PHY protocol and performs filtering.

The communication unit may also include a switch function for switching the transmission and reception functions.

The processors 1011 and 1021 implement the functions, processes, and/or methods proposed in this disclosure. The layers of the air interface protocol may be implemented by the processors.

The processors may be represented by a controller, a control unit, a computer, or the like.

The memories 1012 and 1022 are coupled to the processors and store protocols or parameters for performing the methods proposed in this disclosure.

The processors 1011 and 1021 may include application-specific integrated circuits (ASICs), other chipsets, logic circuits, and/or data processing devices. The memories may include read-only memory (ROM), random access memory (RAM), flash memory, memory cards, storage medium, and/or other storage devices. The communication units may include a baseband circuit for processing a radio signal. When the embodiment is implemented by software, the above-described technique may be implemented as modules (processes, functions, etc.) which perform the above-described functions.

A module may be stored in memories and executed by the processors. The memories may be within or outside the processors and may be coupled to the processors by well known means.

The output unit (display unit) is controlled by the processors, and outputs information output from the processors together with a key input signal generated by a key input unit and various types of information signals from the processors.

The embodiments are described separately with reference to the accompanying drawing, but the embodiments illustrated in the respective drawings may be merged to implement a new embodiment. It is also within the scope of the present invention to design a computer-readable recording medium in which a program for executing the previously described embodiments is recorded according to the needs of those skilled in the art.

The configuration and method of the embodiments described above in the present disclosure described above are not limited in its application, but all of some of the embodiments may be selectively combined to be configured into various modifications.

The method proposed in this disclosure may be implemented as codes that can be read by a processor-readable recording medium provided in a network device. The processor-readable recording medium may include every type of recording device in which data that can be read by a processor, for example, a ROM, a RAM, a CD-ROM, a magnetic tape, a floppy disk, an optical data storage device, and the like. The processor-readable medium also includes implementations in the form of carrier waves such as transmission via the Internet.

Also, the processor-readable recording medium may also be distributed to computer systems connected by a network so that the processor readable codes are stored and executed in a distributed fashion.

### INDUSTRIAL APPLICABILITY

The present disclosure uses a method for performing access with a moving cell in a wireless communication system.

1. A method for performing an access procedure with a moving cell, by a user equipment (UE), in a wireless communication, the method comprising:
receiving, from a base station (BS), first system information (SI) including information related to a moving cell access; and
determining whether to access the moving cell based on the information related to the moving cell access,
wherein the information related to the moving cell access includes at least one of closed subscriber group (CSG) indication information indicating whether a cell is a CSG cell or a normal cell, a CSG identity for identifying a CSG cell, a moving cell ID (MCID) for identifying a moving cell, and moving cell indication information indicating accessibility to a moving cell.

2. The method of claim 1, further comprising:
receiving second SI including information on mapping between the CSG ID and the MCID.

3. The method of claim 2, wherein
the determining whether to access the moving cell includes:
determining whether the CSG ID included in the first SI is present in a CSG whitelist retained by the UE.

4. The method of claim 3, wherein
when the CSG ID included in the first SI is not present in the CSG whitelist, the UE does not access the moving cell.

5. The method of claim 3, further comprising:
when the CSG ID included in the first SI is present in the CSG whitelist, determining whether there is a mapping relationship between the CSG ID and the MCID through information on mapping between the CSG ID and the MCID.

6. The method of claim 5, wherein
when the mapping relationship between the CSG ID and the MCID is set, the UE does not access the moving cell.

7. The method of claim 5, further comprising:
when the mapping relationship between the CSG ID and the MCID is set,
checking moving cell indication information corresponding to the MCID; and
determining whether to access the moving cell on the basis of a result of checking the moving cell indication information.

8. The method of claim 7, further comprising:
when the moving cell indication information indicates permission for accessing the moving cell, performing an access procedure with the moving cell through detection of the MCID.

9. A method for performing an access procedure with a moving cell, by a user equipment (UE), in a wireless communication system, the method comprising:
receiving, from a base station (BS), a master information block (MIB) through a physical broadcast channel (PBCH); and
receiving a control format indicator (CFI) through a physical control format indicator channel (PCFICH) from the BS,
wherein
the MIB and the CIF include information related to a moving cell access and
the PBCH and the PCFICH are scrambled to a physical cell identity (PCID) of the moving cell.

10. The method of claim 9, further comprising:
performing an access procedure with the moving cell on the basis of the received MIB and CFI.

11. The method of claim 9, wherein
the PCID of the moving cell is determined using at least one of an ID of a primary synchronization signal (PSS), an ID of a secondary synchronization signal (SSS), and an ID of a new synchronization signal (NSS).

12. The method of claim 11, wherein
the PCID of the moving cell is determined by N_{ID}^{Cell}=3N_{ID}⁽³⁾+N_{ID}⁽²⁾,
where N_{ID}⁽²⁾ indicates the ID of the SSS and N_{ID}⁽³⁾ indicates the ID of the NSS.

13. The method of claim 11, wherein
the ID of the NSS is determined by N_{ID}⁽³⁾=(N_{ID}⁽²⁾+x_n)mod 167.

14. A user equipment (UE) for performing an access procedure with a moving cell in a wireless communication system, the UE comprising:
a communication unit transmitting and receiving a radio signal to and from an external source; and
a processor functionally coupled to the communication unit,
wherein the processor performs control to
receive first system information (SI) including information related to a moving cell access from a base station (BS) and
determine whether to access the moving cell on the basis of the information related to the moving cell access,
wherein the information related to the moving cell access includes at least one of closed subscriber group (CSG) indication information indicating whether a cell is a CSG cell or a normal cell, a CSG identity for identifying a CSG cell, a moving cell ID (MCID) for identifying a moving cell, and moving cell indication information indicating accessibility to a moving cell.

15. A user equipment (UE) for performing an access procedure with a moving cell in a wireless communication system, the UE comprising:
a communication unit transmitting and receiving a radio signal to and from an external source; and
a processor functionally coupled to the communication unit,
wherein the processor performs control to:
receive a master information block (MIB) through a physical broadcast channel (PBCH) from a base station (BS) and
receive a control format indicator (CFI) through a physical control format indicator channel (PCFICH) from the BS,
wherein
the MIB and the CIF include information related to a moving cell access and
the PBCH and the PCFICH are scrambled to a physical cell identity (PCID) of the moving cell.

16. The method of claim 2, wherein
the mapping information between the CSG ID and the MCID is information on a relationship in which one MCID group including the whole MCIDs is mapped to one CSG ID or a relationship in which N number of MCID groups are mapped to N number of CSG IDs in a one-to-one manner.
